(19) United States
(12) Patent Application Publication
(10) Pub. No.: US 2012/0234736 A1
(43) Pub. Date: Sep. 20, 2012

(54) High g perforated plate

(76) Inventors: Grant Young, Tulsa, OK (US); Ray Young, Glenpool, OK (US); Donald L. Dunning, Chapin, SC (US)

(21) Appl. No.: 13/484,622

(22) Filed: May 31, 2012

Related U.S. Application Data
(63) Continuation-in-part of application No. 13/204,605, filed on Aug. 5, 2011.
Application No. 13/204,605 is a continuation-in-part of application No. 12/804,546, filed on Jul. 24, 2010.

(51) Int. Cl. B07B 1/46; B07B 1/28

(52) U.S. Cl. 209/364; 209/392

(57) ABSTRACT

A perforated plate for use in a high g vibratory device in the separation of solid particles within a slurry. The plate is rigid and has perforations with a span of no greater than 3/16 inch.

### CROSS-REFERENCE TO RELATED APPLICATIONS

Continuation in part of U.S. patent application Ser. No. 13/204,605

### STATEMENT REGARDING FEDERALLY SPONSORED RESEARCH

Not Applicable

### FIELD OF THE INVENTION

This invention relates to a perforated plate used within a vibrating screen device in a high-g environment for separating out rigid particles.

### BACKGROUND OF THE INVENTION

Shakers or other vibrating screen devices can be used to separate solids from fluids. Some shakers have multiple screens with a porous material for separating the solids from the fluid. The fluid passes through the porous material and the solids remain atop the screen to be conveyed off. The screens can have a stepped arrangement. Solids fall from the discharge end of each screen to the feed end of the next screen. When rigid solid material such as sand and/or metal particles like mill scale are being separated from a fluid, these rigid solids can often become stuck within the pores/openings of the woven wire cloth and are not conveyed off the screen. This can result in screen binding.

A woven wire cloth screen has some flexibility. The wires move to some extent. This movement allows a particle of a particular size and/or shape to wedge itself between two or more wires in a screen opening. The wires can move over (or flex) as the particle forces its way into the opening. The force on the particle includes the g force of the vibrating shaker. The forces exerted by the wires on the side of the particle can become greater and greater as one or more wires tries to move out of the way. If there is enough movement the particle may be sized such that it goes on through the opening. Otherwise the particle gets stuck. The net result is the wires provide a spring load on the sides of the particle to trap the particle in the opening. When material builds up on the screen, the separation process must often be temporarily stopped to clean the screen. The rigid solids caught within the openings of the woven wire cloth are difficult to remove. Often a very stiff brush is used to scrub them out of the openings/pores. Water spray is often insufficient to remove the particles.

The action of the brush can move the wires while as the same time disturbing the particle resulting in removal of the blinding particles. In addition to having to stop the process, this can eventually shorten the life of the screen. This is particularly true in a high g environment as material is more strongly forced against the screen and consequently into the openings/pores. There is a need for a screen or plate used to separate fluid from solid rigid materials in a high g environment that minimal binding of solids.

The instant invention, with its multiple embodiments as disclosed within this application, provides a screen/plate that fills this need. The perforated plate openings as disclosed in the instant invention are essentially rigid and do not appreciably change in size. Nor do they flex to accommodate a particle and/or hold a particle in place. As a result, most particles either go through the oval or circular opening or they do not. The net result is a “screen” which does not normally blind with rigid particles. Particles that sit in the opening can often be back sprayed and washed out of the opening since there is no pinching force holding them in place. They are also much easier to mechanically remove since they are not held in place.

The art referred to and/or described within this application is not intended to constitute an admission that any patent, publication or other information referred to herein is “prior art” with respect to this invention. In addition, this section should not be construed to mean that a thorough search has been made or that no other pertinent information as defined in 37 C.F.R. §1.56(a) exists.

The patent application titled “Vibrating Screen Device” and having patent application Ser. No. 12/658,686 is incorporated by reference in its entirety. The vibratory screen device of this previously filed patent application can be used in many embodiments disclosed herein.

All US patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well, only for the purposes of complying with 37 C.F.R. 1.72. The abstract is not intended to be used for interpreting the scope of the claims.

### BRIEF SUMMARY OF THE INVENTION

In at least one embodiment of the invention, a perforated plate is used in the high g vibratory device wherein the plate has perforations with a span of no greater than 3/16 inch and of rigid construction. The plate may have a length of at least 12 inches. The essentially rigid perforated plate openings will not substantially change in size or shape within the high g environment to the degree a wire mesh screen does. The perforated plate openings will not flex to the degree that a wire mesh screen often flexes when a rigid particle is forced into an opening. This flex in the openings is believed to result in the rigid particle being held fast as the opening exerts pressure on the particle in an effort to return to its former shape.

In at least one embodiment the perforations have a span of between 1/16 and 0.027 inch inclusive.

In at least one embodiment each perforation is spaced within 0.2 inch of at least one other perforation. In at least one embodiment the perforations are oval in shape.

In at least one embodiment the high g vibratory device creates at least 2 g's in the vertical direction.

In at least one embodiment the perforations comprise greater than 10% of the surface area of the plate.

In at least one embodiment the perforations are distributed evenly over a majority of the surface area of the plate. The majority of the surface area is the working area.

In at least one embodiment the perforated plate is utilized within a high g environment.

In at least one embodiment the perforated plate has a polished surface.

It should be noted that additional embodiments include any combination of the above disclosures under the Brief Summary of the Invention heading.

In at least one embodiment a perforated plate is disposed within a vibratory device creating at least a vertical 2 g environment. The perforated plate has perforations with a span of between 0.025 and 3/16. The plate is rigid such that the perforations do not have a substantial change in shape when exposed to the vertical 2 g environment.

In at least one embodiment a vibratory device has at least two perforated plates.

In at least one embodiment a high g vibratory device has at least one perforated plate having perforations with a span of no greater than 3/16 inch. Additionally, each perforation is spaced within 0.4 inch of at least one other perforation, and the perforated plate(s) have rigid construction and a length of at least 12 inches.

In at least one embodiment of the invention multiple screens are used with the screens being sequentially arranged. As used in this application screens that are “sequential” or that have a “sequential configuration” convey material from one screen to the next screen in the sequence and/or allow material (solid or fluid) to pass through the pores/perforations of one screen and/or over the edges of one screen to the next screen in sequence. So, a sequential configuration includes but is not limited to 1) screens positioned one above another, 2) screens adjacent one another without a substantial lateral gap between them such that material conveys from one screen to the next (screens can actually butt up against one another), and 3) screens configured in a stepped down configuration such that the conveyed material from one screen falls off the edge of the one screen onto the next screen in the sequence.

Also, a screen that is “sequentially after” is a screen in the sequence that receives material (solid or fluid) from another screen in the sequence. A screen that is “sequentially before” is a screen in the sequence that transfers material (solid or fluid) to another screen in the sequence. Obviously if there are more than two screens in the sequential configuration at least one will be both “sequentially after” another screen and “sequentially before” another screen.

In at least one embodiment of the invention the perforated plates are sprayed from below or above to help clear solid material that may be stuck on or in the pores/perforations of the screen.

In at least one embodiment of the invention, the fluid is a water based fluid, an oil based fluid, a gelatinous based fluid, a plasma based fluid, or any combination thereof.

In at least one embodiment of the invention, the fibrous matter is biological matter, petroleum based matter, geologic matter, or any combination thereof.

The patent application titled “Vibrating Screen Device” and having patent application Ser. No. 12/658,686 is incorporated by reference. The vibratory screen device of this previously filed patent application can be used in many embodiments disclosed herein.

These and other embodiments which characterize the invention are pointed out with particularity in the claims annexed hereto and forming a part hereof.

However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a perspective view of a portion of a prior art wire square mesh that can be used in a separating screen

FIG. 2 is a perspective view of a portion of wire square mesh that has rigid particles material caught in the wires.

FIG. 2a is an enlarged top view of a portion of wire square mesh that has rigid particle material caught in the wires.

FIG. 3 is a perspective view of a portion of a perforated screen having oval perforations.

FIG. 3a is a perspective view of a portion of a perforated screen illustrating the span of a perforation as well as illustrates a particle which does not bind the opening/perforation because of the rigidity of the plate.

FIG. 4 is a schematic perspective view of two screens with the upper screen having larger sized pores than the lower screen.

FIG. 5 is a schematic perspective view of three screens with the uppermost screen having larger sized pores than the two lower screens.

FIG. 6 is a perspective view of a shaker having screens in a stepped down configuration.

FIGS. 7a and 7b are cross-section side views of perforated plates.

FIG. 8 is a perspective view of a non-flat perforated plate.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. Unless otherwise stated, the term “oval” includes an oval, ellipse, circle, or any other shape without corners. Additionally, within this application the term “proximal” end of the shaker or screen is the end in which the material to be separated is introduced; the “distal” end of the shaker or screen is the end toward which the separated solids are conveyed. For purposes of this application, the term “perforation” refers to a hole formed by removing material from a sheet or plate or moving material on the plate to form a hole; a “perforated plate” is a sheet or plate having holes formed by removal of material from the sheet or plate or by moving material on the sheet of plate. Though there can be other methods of creating these perforations some methods include by punching holes out with a press or with fluid or gas pressure; grinding holes; cutting holes through by use of a saw, laser, liquid, or gas; chemically creating the holes, or any combination of these. Rigidity in the screen/plate can be helpful in high g applications. The screen or plate can be constructed of a variety of materials and composites. Some screens/plates are constructed of a metal, a hard plastic, a ceramic, or any combination of these. Surface hardening of a material can also be used to achieve a desired rigidity.

As used in this application, “bearing area” is the solid surface area of plate/screen as opposed to the “open” areas where the pores are. These open areas in the inventive plate/screen of this application are often referred to as perforations.

Finally, as used in this application when describing or stating that solid rigid materials are separated from a slurry (including combinations of rigid particles, or rigid particles in combination with softer materials and/or fibrous material), the solid rigid material can still have fluid mixed with it, however it has less than the original wet material.

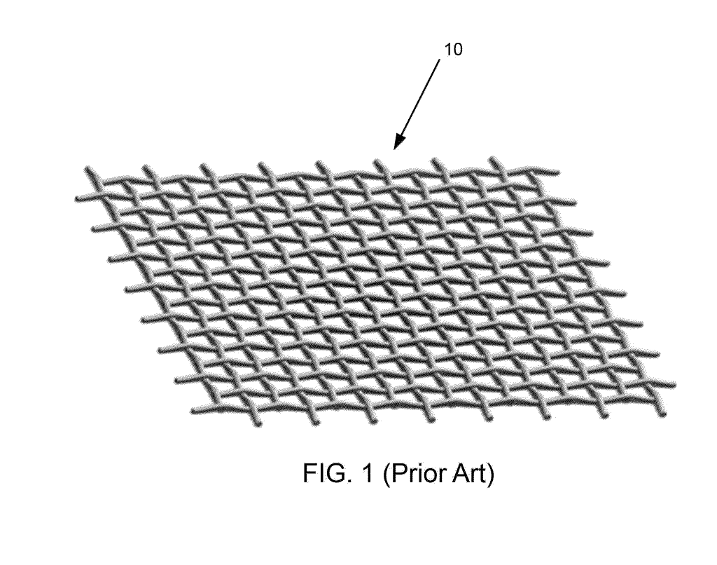

In FIG. 1 a Prior Art portion of woven wire square mesh screening 10 is shown. The term woven here is used to describe the product rather than the method of construction even if the actual method for constructing the screen 10 is weaving. There are many weaves, all woven screens consist of one form or another of over under construction. This material has been used to remove coarser solids from finer solids in a wet or dry mixture. In high g applications of vibratory devices, the woven screens can flex such that the shape of the pore is changed and material that is forced into the pore is pinched or squeezed such that it is held tightly as the pore exerts compressive forces in an effort to return to its original shape. Rigid particles being separated from a fluid can often get caught within the pores and pinched between the wires of the woven screen.

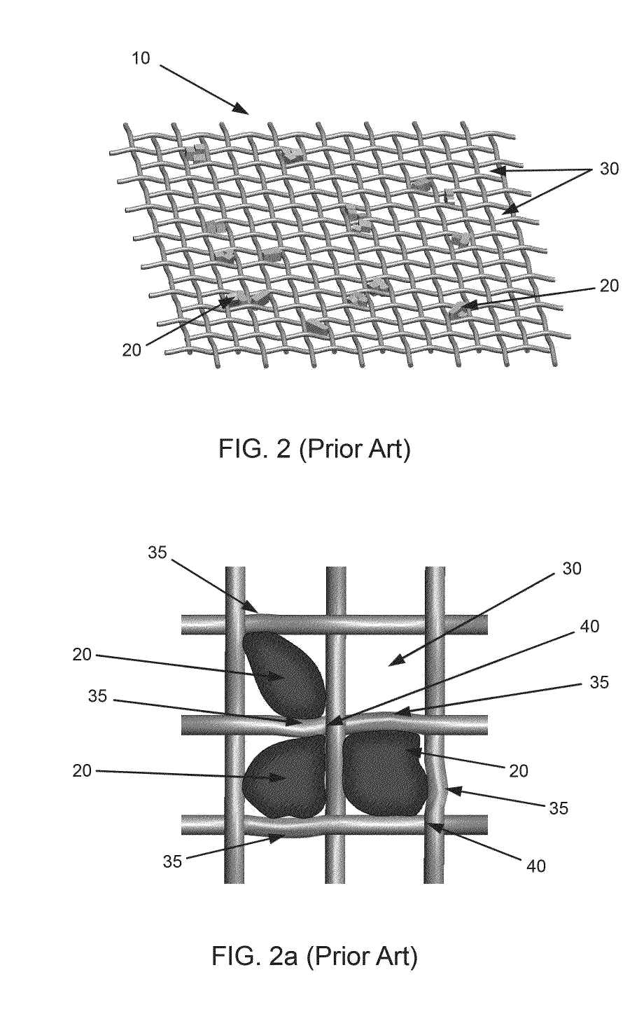

Material such as mill scale or sand can be wedged into a pore. Due to pore deformation when exposed to a high g environment the scale can be pinched or squeezed between the wires. This problem is exacerbated by the screens having a smaller bearing area around each pore, thus increasing the tendency of the solid material to go through a pore rather than to lie on top of the screen and then be conveyed off. When the wetted material is getting caught within the pores, blinding of the screening or screen 10 can occur. This is shown in the screens shown in FIGS. 2 and 2a where material 20 from the wetted material to be processed is caught in the pore openings 30. As shown in the magnified view of FIG. 2a, the material 20 can wedge into the pore/opening and be held tightly due to the flexed wire portions 35. The flexed wire portions want to return to their original shape thereby exerting a force on the solid particle 20 that acts to hold the particle tightly within the opening 30. This can lead to screen binding and far less efficient separation.

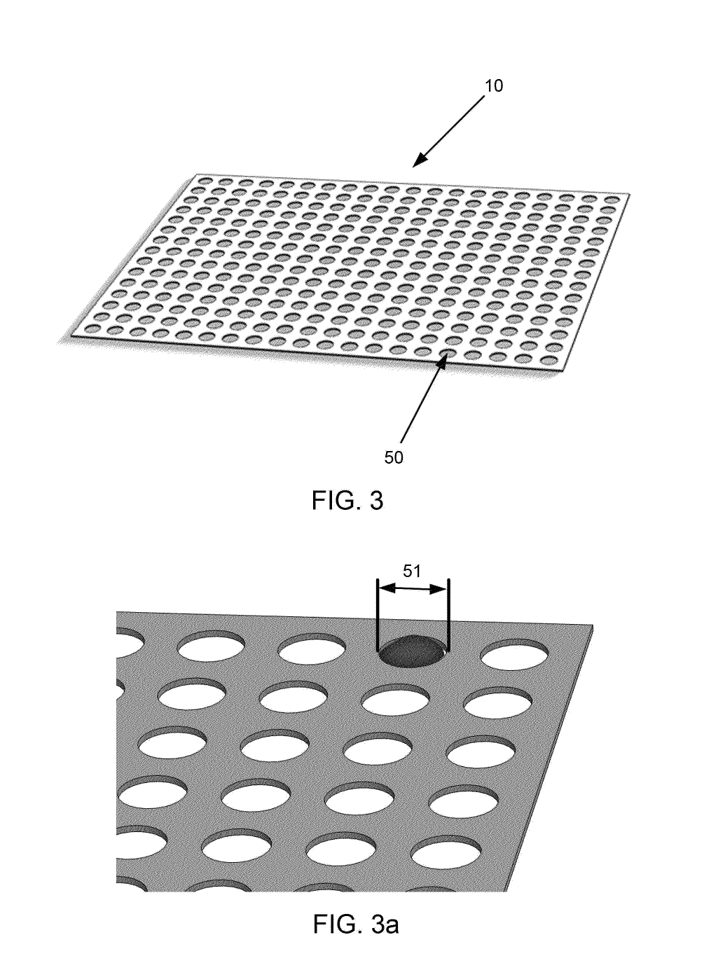

The perforations of the inventive plate and process greatly reduce the frequency at which rigid particles, as well as other solids, gets caught in the openings of a screen. As shown in FIG. 3 the perforated screen 10 has oval shaped perforations 50 with a span 51 (illustrated in the enlarged screen portion in FIG. 3a). The span 51 extends from one end of a perforation to the other end across the greatest length dimension of the perforation 50. The oval perforations of the inventive plate do not flex within the high g environment to the degree the openings of woven screens do. Thus, as illustrated in FIG. 3a, a solid particle 20 may enter the perforation 50 but the perforation does not deform due to the rigidity of the perforated plate/screen 10 and the solid particle 20 is not securely caught in the perforation thus greatly reducing the risk of binding. The perforated screen 10 can be constructed with small perforations having a span of less than 0.1 inch. In some embodiments the span is 1/32 inch or smaller. These small perforations can allow fluid to pass through while they can also ameliorate the issue of rigid particles blinding the screen.

The perforated plates having perforations 50 do not flex as readily as the woven screens of FIGS. 1, 2, and 2a. In fact if the screen/plate is rigidly constructed there is very little flexing of the plate. This is particularly important in reducing blinding in separation applications that have particles that get pinched or squeezed by the pore 30 itself Mill scale and sand separations are such applications.

Additionally a larger bearing area works better for some screening applications. For example, the large bearing area is also advantageous for screening solids which have agglomerated together. Agglomerated solids tend to stay together because of the large bearing area between the perforated plate openings.

Woven wire screens have knuckles which in some applications interfere with conveyance of solids. Knuckles provide a rough surface which solids can get caught on. These knuckles also provide a rough surface which interferes with solids sliding and thus conveyance is hindered. The perforated plates within this application can be made to provide a smooth surface which allows solids to slide along the surface of the plate. Solids such as mill scale which have a flat plate shape tend to lay flat on the flat plate surface. This means they tend to slide over the circular or round openings in the plate instead of getting caught.

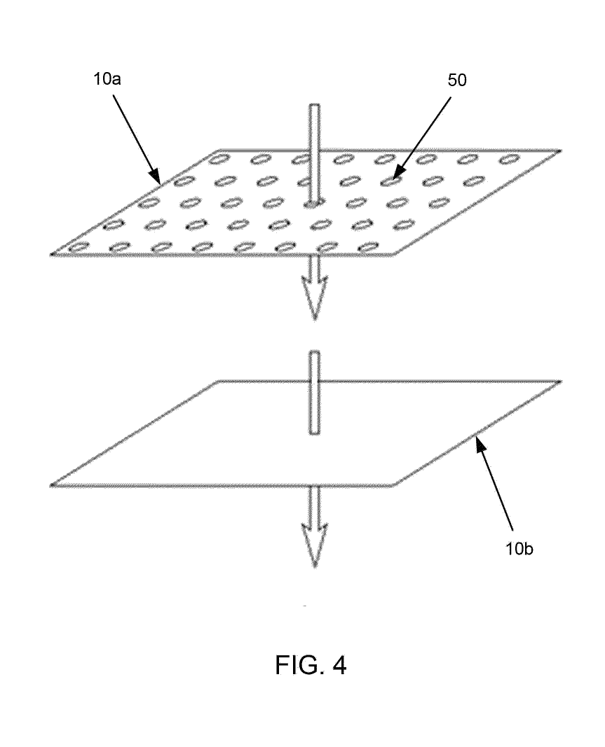

In some embodiments, as schematically shown in FIG. 4, separating the wet solid matter into solid material and fluid can be performed using at least one perforated plate/screen 10a and at least one non-perforated plate/screen 10b (e.g. standard wire mesh screen). When placed on a perforated plate 10a, the rigid solid matter (wet or not) can be vibrated by vibration of the plate 10a such that the larger solid particles remains on the upper surface of the perforated plate 10a until it is conveyed off of the perforated plate. Fine material and fluid can pass through perforations 50 of the perforated plate 10a and onto non-perforated plate 10b where blinding of the screen is not as likely because of the diminished amount or complete lack of rigid solid material. The screens 10a and 10b within a vibrating shaker can separate the larger solid particles from the finer solid particles by collecting the larger solid particles as they are conveyed by perforated plate/screen 10a and collecting the finer particles as they are conveyed by non-perforated plate/screen 10b.

FIG. 4 need not have a non-perforated screen as described above. A perforated plate can also be used in the place of the non-perforated plate.

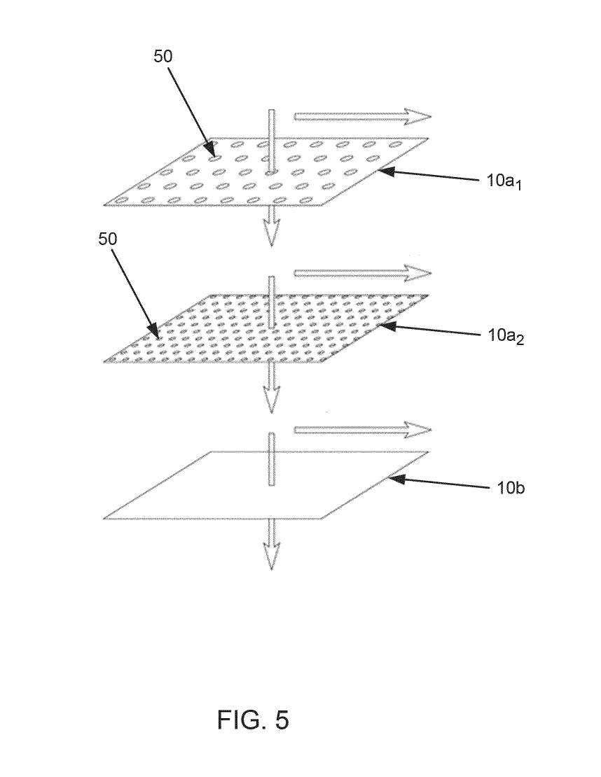

In FIG. 5 multiple perforated plates 10a₁ and 10a₂ with non-perforated plate 10b (e.g. a standard wire mesh) are shown. Here, perforated plate 10a₁ has larger perforations 50 than does perforated plate 10a₂. Solid particulate matter disposed on perforated plate 10a₁ can allow fluid, fine material and some smaller particles through the larger perforations 50 of perforated plate 10a₁, but without the same blinding issue as the perforations have a diminished rate in particles being caught within the perforations 50.

Plate 10a₂ can then allow the fluid and fine material to pass through its perforations 50 and transfer onto non-perforated plate 10b. On the non-perforated plate 10b there is further separation as the fines do not pass through the holes of the non-perforated plate while the fluid does. The vibratory action on each of the screens 10 of FIG. 5 can convey the separated material into separate areas for collection.

FIG. 5 also does not need to have a non-perforated screen as described above. A perforated plate can also be used in the place of the non-perforated plate.

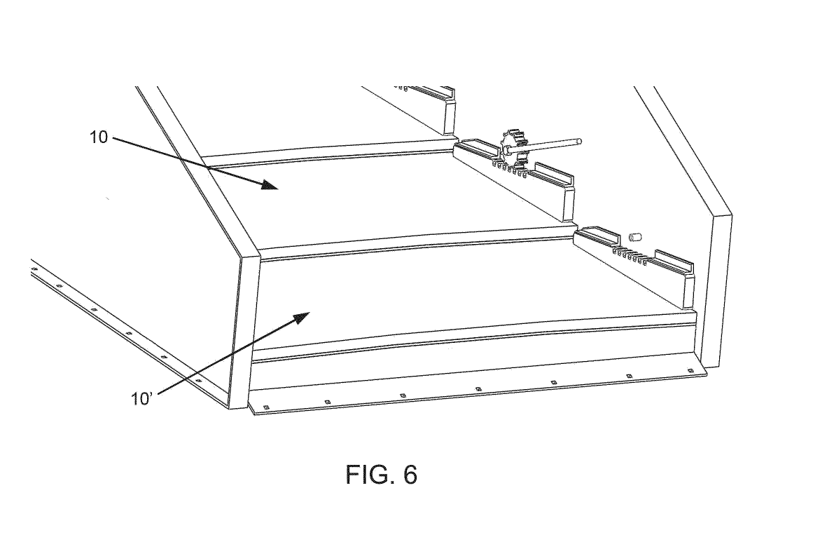

While the screens/plates 10 as illustrated in FIGS. 4 and 5 show the screens/plates disposed directly above/beneath the other screen/plate(s) 10, in some embodiments the screens 10 are arranged in a sequential and/or stepped configuration as shown in FIG. 6. In FIG. 6 the screens/plates 10 are disposed within a vibrating screen device 70. Here, the solid matter can have fluid and/or fine materials pass through each screen. The solid material is conveyed along each screen/plate 10 and transfers to the next lower screen/plate 10 until it transfers off the vibrating screen device 70. In some embodiments the perforated plates, instead of being stepped down are simply butted up against each other such that the material is conveyed from one screen surface to an adjacent screen surface. In some embodiments the vibrating screen device 70 has a vibratory motion that is oval shaped. In some embodiments the vibrating screen device 70 has a vibratory motion that is elliptical. In some embodiments the vibrating motion is linear. In some embodiments the vibrating screen device 70 has a vibratory motion of about 1800 cycles per minute. Vibratory motion of about 500 to about 3600 cycles per minute can also be used in some embodiments.

In some embodiments, the solid material can be conveyed along each screen in paths that are substantially straight. In some embodiments that paths are substantially parallel to one another. Thus, regardless of where each portion of solid material is put or transferred onto a particular screen, each portion can move in the substantially same direction. It is understood that solids conveyance requires that the solids leave the surface of the perforated plate, resulting in the solids falling back at a different location on the perforated plate to be advanced forward by the vibrating perforated plate. In fact oval shaped vibration as well as surface tension in liquid slurries can result in the solids/liquid balling up. Within this application, such movement is consistent with the terms “substantially straight” and “substantially parallel” as the material is moving generally in a straight and/or parallel path when viewed looking straight down (top view) at the screen surface. When viewing the conveyance from a side view oval shaped movement (sometimes specifically elliptical motion) may be observed. It should be noted that there will be instances in which even from the top view the material can on occasion move in a non-linear and/or non-straight manner, but when the motion is described as substantially straight the movement is generally straight.

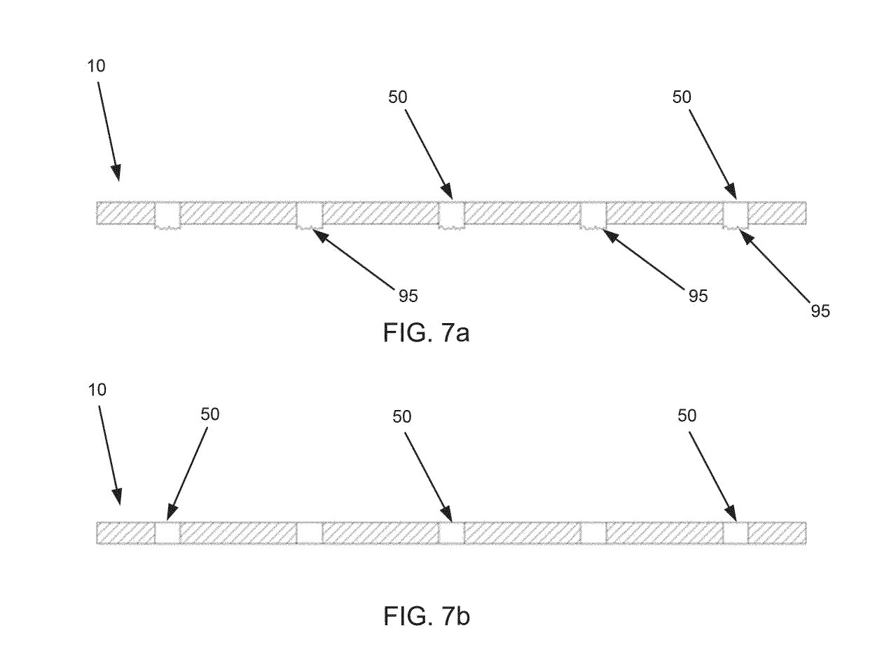

In some embodiments the perforated screen 10 has a bottom side wherein portions of the screen disposed about or adjacent to each perforation extend from the screen creating a crown 95 having sharp edges as shown in the cross-sectional side view of FIG. 7a. The crown 95 can tend to more readily catch some rigid material that begin to pass through the perforations 50 of the perforated screen 10. By removing the crowns 95, some rigid material is less likely to be caught. Rounded edges on the underside of the screen would also be an improvement. These rounded edges would not tend to catch particles as readily. One method of fabricating an uncrowned perforated plate, which is a perforated plate with either rounded or absent crowns 95, is through scotch brighting the surface. Also, by vibrating an abrasive slurry with abrasives that are small and round but too large to pass through the perforation 50 or get stuck in the perforation 50, the crown 95 can be rounded or removed (as shown in FIG. 7b).

These crowns can also encourage some solids to catch in the pore as it basically extends the depth of the hole and provides more opportunity for a solid to catch.

In some embodiments, spray nozzles can be used above the screen to break up clumps of material to be separated. This can also be desirable to help keep the product moving over the surface of the screen 10.

In some embodiments, spray nozzles can be used under the screen 10 to clear any solid materials that get caught on the underside of the screen 10 or to force other solid materials that sit in the opening back to the top side. For example, one or more nozzles could be affixed to the vibratory screen device shown in FIG. 6 above one or more screens and/or positioned below one or more screens. The nozzle(s) could be placed on the cross members above the vibratory screen device or below the screen. Additionally, one or more nozzles could be positioned on a track set above and/or below the screen. This arrangement can allow the nozzle(s) to be moved on the track to be positioned and/or repositioned. The track can run from a proximal side of the screen(s) to a distal side. The track can also run across the width of the screen. It should be noted that a vibratory screen device having a single screen can also have nozzles placed as described above. A spray wash can also be used to clear grease and other contaminates which may coat the opening.

In some embodiments wet or non-wet solid material can be separated using a vibratory shaker having perforated plates with perforations no larger than 3/16 inch.

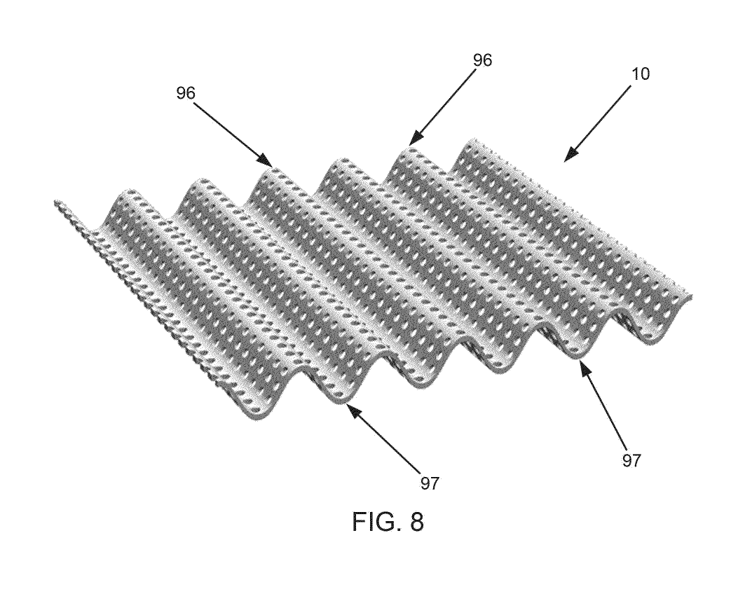

As shown in FIG. 8, the perforated plate does not need to be flat. These plates increase the contact area for a given screen size design. There can be a single or multiple raised portion(s). In fact the plate/screen 10 can have a corrugated or sinusoidal shape with peaks 96 and valleys 97. The screen 10 can also include a mixture of flat and non-flat portions; examples of the flat portions are shown in FIGS. 1-7 and an example of the non-flat portions is shown in FIG. 8.

In some embodiments multiple sequential screens are used (see FIG. 6). It is often desirable to initially remove excess liquid with fine perforated screens which separate the fine solid materials from the liquid. These fine solid materials can mat together as excess liquid is removed. To further dry the matted materials a coarser perforated plate can be used. The fine solid materials remain on the larger mesh screen because they are caught in the matted material. Thus, in some embodiments, once the majority of the fluid is gone the mats of solids constrain each other, effectively agglomerating into larger solids which will not go thru larger holes.

For the purposes of this disclosure, like reference numerals in the figures shall refer to like features unless otherwise indicated.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A perforated plate for use in a high g vibratory device, the plate having perforations with a span of no greater than 3/16 inch, the plate being of rigid material.

2. The perforated plate of claim 1 wherein the perforations have a span of between 1/16 and 0.027 inch inclusive.

3. The perforated plate of claim 1 wherein the high g vibratory device includes at least one spray device disposed beneath the plate, the at least one spray device forcing a fluid through perforations of the plate.

4. The perforated plate of claim 1 wherein the perforations are oval in shape.

5. The perforated plate of claim 1 wherein the high g vibratory device creates at least 2 g's normal to the screen.

6. The perforated plate of claim 1 wherein the perforations comprise greater than 10% of the surface area of the plate.

7. The perforated plate of claim 1 wherein the perforations are distributed evenly over a majority of the surface area of the plate.

8. The perforated plate of claim 1 utilized within a high g environment for separation of solid particles within a slurry.

9. The perforated plate of claim 1 having a polished surface.

10. A perforated plate disposed within a vibratory device, the vibratory device creating at least a 2 g environment normal to the screen, the perforated plate having perforations with a span of between 0.025 and 3/16 in., the plate being rigid such that the perforations maintain a substantially consistent shape during vibration within the 2 g or greater environment, the consistent shape minimizing entrapment of rigid particles within the perforations.

11. The perforated plate of claim 10 wherein the perforations are oval in shape.

12. The perforated plate of claim 10 disposed within a vibratory device having at least one other perforated plate.

13. A high g vibratory device having at least one perforated plate, the at least one perforated plate having perforations with a span of no greater than 3/16 inch, the at least one perforated plate being of rigid construction and having a length of at least 12 inches.

14. The high g vibratory device of claim 13 wherein the perforations have a span of between 0.025 and 3/16 inch inclusive.

15. The high g vibratory device of claim 13 having at least one spray device disposed beneath the plate, the at least one spray device forcing a fluid through perforations of the plate.

16. The high g vibratory device of claim 13 wherein the perforations are oval in shape.

17. The high g vibratory device of claim 13 creating at least 2 g's in a direction normal to the surface of the perforated plate.

18. The high g vibratory device of claim 13 wherein the perforations comprise greater than 10% of the surface area of the at least one perforated plate.

19. The high g vibratory device of claim 13 wherein the perforations are distributed evenly over a majority of the surface area of the plate.

20. The high g vibratory device of claim 13 having a polished surface.
